(19) United States
(12) Patent Application Publication
(10) Pub. No.: US 2025/0389814 A1
(43) Pub. Date: Dec. 25, 2025

(54) Control Method and Device, and Aerial Vehicle

(71) Applicant: SZ DJI TECHNOLOGY CO., LTD., Shenzhen (CN)

(72) Inventor: Junxi WANG, Shenzhen (CN)

(21) Appl. No.: 18/640,546

(22) Filed: Apr. 19, 2024

Related U.S. Application Data
(63) Continuation of application No. PCT/CN2021/130758, filed on Nov. 15, 2021.

(51) Int. Cl. G01S 7/40; B64D 45/04; G01S 13/935

(52) U.S. Cl. CPC G01S 7/4008; B64D 45/04; G01S 13/935

(57) ABSTRACT

A control method includes obtaining a flight mode of an aerial vehicle and adjusting a beam direction relative to the aerial vehicle and/or a beam width of an antenna of a radar module of the aerial vehicle according to the flight mode. The flight mode includes at least one of scent, hover, route flight, terrain-following flight, or landing.

### CROSS-REFERENCE TO RELATED APPLICATION

This application is a continuation of International Application No. PCT/CN2021/130758, filed Nov. 15, 2021, the entire content of which is incorporated herein by reference.

### TECHNICAL FIELD

The present disclosure relates to the control field and, more particularly, to a control method, a control device, and an aerial vehicle.

### BACKGROUND

An aerial vehicle is equipped with a radar. During the flight of the aerial vehicle, an obstacle in the environment where the aerial vehicle is located is detected by the radar. Thus, the aerial vehicle is prevented from colliding with the obstacle.

However, the radar is fixedly mounted at the aerial vehicle or rotates around a predetermined axis at the aerial vehicle. The radar is not able to perform an adaptive adjustment during the flight of the aerial vehicle. Thus, safety risks exist in some scenarios.

### SUMMARY

In accordance with the disclosure, there is provided a control method. The method includes obtaining a flight mode of an aerial vehicle and adjusting a beam direction relative to the aerial vehicle and/or a beam width of an antenna of a radar module of the aerial vehicle according to the flight mode. The flight mode includes at least one of scent, hover, route flight, terrain-following flight, or landing.

Also in accordance with the disclosure, there is provided a control device, including one or more processors and one or more memories. The one or more memories store an executable instruction that, when executed by the one or more processors, causes the one or more processors to obtain a flight mode of an aerial vehicle and adjust a beam direction relative to the aerial vehicle and/or a beam width of an antenna of a radar module of the aerial vehicle according to the flight mode. The flight mode includes at least one of scent, hover, route flight, terrain-following flight, or landing.

### BRIEF DESCRIPTION OF THE DRAWINGS

FIG. 1 is a schematic flowchart of a control method consistent with an embodiment of the present disclosure.

FIG. 2 is a schematic flowchart of another control method consistent with an embodiment of the present disclosure.

FIG. 3 is a schematic diagram showing a detection range of a radar when an aerial vehicle is ascending consistent with an embodiment of the present disclosure.

FIG. 4 is a schematic diagram showing a detection range of a radar when an aerial vehicle hovers consistent with an embodiment of the present disclosure.

FIG. 5 is a schematic diagram showing a detection range of a radar when an aerial vehicle flies on route consistent with an embodiment of the present disclosure.

FIG. 6 is a schematic diagram showing a detection range of a radar when an aerial vehicle is landing consistent with an embodiment of the present disclosure.

FIG. 7 is a schematic diagram of an aerial vehicle with a radar module consistent with an embodiment of the present disclosure.

FIG. 8 is a schematic diagram showing a detection direction of a radar module consistent with an embodiment of the present disclosure.

FIG. 9 is a schematic diagram of a radar module consistent with an embodiment of the present disclosure.

### DETAILED DESCRIPTION OF THE EMBODIMENTS

The technical solution of embodiments of the present disclosure is described in detail in connection with the accompanying drawings to make the purposes, technical solutions, and advantages of embodiments of the present disclosure clearer. Described embodiments are some embodiments of the present disclosure, not all embodiments. Based on embodiments of the present disclosure, all other embodiments obtained by those of ordinary skill in the art without creative efforts are within the scope of the present disclosure.

Features described with the terms “first” and “second” in the description and claims of the present disclosure can include one or more of these features, either explicitly or implicitly. In the description of the present disclosure, unless otherwise specified, “a plurality of” means two or more. In addition, “and/or” in the description and claims indicates at least one of the connected objects, and the character “/” generally indicates that the related objects front and after are in an “or” relationship.

In the description of embodiments of the present disclosure, orientational or positional relationship indicated by terms such as “center,” “longitudinal,” “landscape,” “length,” “width,” “thickness,” “upper,” “lower,” “front,” “back,” “left,” “right,” “vertical,” “horizontal,” “top,” “bottom,” “inner,” “outer,” “clockwise,” “counterclockwise” are based on the orientational or positional relationship shown in the drawings. The terms are only used to facilitate the description of embodiments of the present disclosure and simplify the description, rather than indicating or implying that the device or element referred to must have a specific orientation and be constructed and operated in a specific orientation. Therefore, the terms cannot be understood as a limitation to the present disclosure.

In the description of embodiments of the present disclosure, the terms “mount,” “connection,” and “coupling” should be understood in a broad sense. For example, the terms may indicate a fixed connection, a detachable connection, an integral connection, a mechanical connection, an electrical connection, a communication, a direct connection, an indirect connection through an intermediary, internal communication of two components, or interaction relationship of two components. Those of ordinary skill in the art should understand the specific meanings of the above terms in embodiments of the present disclosure according to specific situations.

An aerial vehicle can include any type of vehicle that can move in the air, such as a manned or an unmanned aircraft, which is not limited here. An unmanned aerial vehicle (UAV) is taken as an example to describe the present disclosure. The description is also applicable to any type of aerial vehicle, such as a manned aerial vehicle, e.g., a helicopter or a fixed-wing aircraft. The aerial vehicle can include the UAV, such as an agricultural UAV and an industrial UAV, which is usually equipped with a radar. Taking a millimeter-wave radar as an example, a millimeter-wave radar module can emit a millimeter wave via an antenna and receive a returned wave to detect an obstacle in the environment where the UAV is located to prevent the UAV from colliding with the obstacle. However, the radar is usually fixedly mounted at the UAV or rotates around a predetermined axis at the UAV. The radar cannot perform adaptive adjustment during the flight of the UAV. Thus, safety risks can exist in some scenarios.

Based on this, embodiments of the present disclosure provide a control method, a control device, and an aerial vehicle.

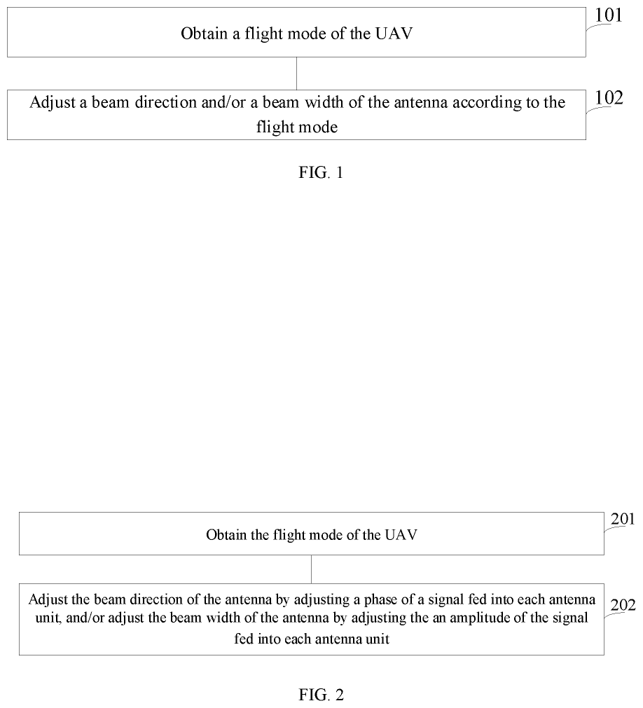

FIG. 1 is a schematic flowchart of a control method consistent with an embodiment of the present disclosure. The control method of embodiments of the present disclosure can be applied to an aerial vehicle, such as a UAV. The aerial vehicle can include a radar module. The radar module can include an antenna. The method includes the following processes.

At 101, a flight mode of the UAV is obtained. The flight mode includes at least one of ascent, hover, route flight, terrain-following flight, or landing.

In embodiments of the present disclosure, in an ascent mode, the UAV can be ascending. In a hover mode, the UAV can keep a spatial position unchanged at a certain height. In a route flight mode, the UAV can automatically fly along a planned route. In a terrain-following flight mode, the UAV can automatically change a flight height according to terrain. In a landing mode, the UAV can land from a certain height.

As mentioned above, flight modes can include, e.g., ascent, hover, route flight, terrain-following flight, and landing. In some other embodiments, the UAV can further include other flight modes, e.g., a flight mode required by a special performance and a flight mode required in a competition.

At 102, a beam direction and/or a beam width of the antenna is adjusted according to the flight mode.

In some embodiments, the beam direction of embodiments of the present disclosure can be a direction of an emitted beam. The beam width of embodiments of the present disclosure can be a width of the emitted beam.

With different flight modes of the UAV, areas that need to be detected can be different. By adjusting the beam direction of the antenna to a desired direction, obstacles in the desired direction can be detected. By adjusting the beam width, obstacles within a corresponding field of view can be detected. Thus, the radar module can detect the area required by the flight mode of the UAV.

In embodiments of the present disclosure, the radar module can detect the area required by the flight mode of the UAV by dynamically adjusting the beam direction and/or the beam width according to the flight mode. Thus, the obstacle avoidance effect of the UAV can be ensured to improve the safety of the UAV during the flight.

FIG. 2 is a schematic flowchart of another control method consistent with an embodiment of the present disclosure. The method includes the following processes.

At 201, the flight mode of the UAV is obtained. The flight mode includes at least one of ascent, hover, route flight, terrain-following flight, or landing.

For the description of this process, reference can be made to process 101 described above, which is not repeated here.

At 202, according to the flight mode, the beam direction of the antenna is adjusted by adjusting a phase of a signal fed into each antenna unit, and/or the beam width of the antenna is adjusted by adjusting an amplitude of the signal fed into each antenna unit.

The antenna can include a phased array antenna. The phased array antenna can include a plurality of antenna units. The amplitudes and phases of the antenna units can be adjusted separately. Therefore, the beam width and the beam direction of the antenna can be controlled by the phased array. For example, based on the flight mode of the UAV, the phase of the signal fed into each antenna unit can be changed to adjust the beam direction of the antenna to cause the beam of the antenna to face the area that needs to be detected according to the current flight mode, and/or the amplitude of the signal fed into each antenna unit can be adjusted to adjust the beam width of the antenna to adjust the beam width of the antenna to the width required by the flight mode. For example, the beam can be adjusted to a narrow beam, medium-width beam, or wide beam.

In addition, when the beam width is adjusted to a narrow beam, the energy (power) of the beam can be increased, which improves the detection of a weak target. For example, M (a positive integer, including 2, 3, 4, 5, etc.) emission channels can be configured to synthesize the emitted beams. Compared to a single-channel antenna, the power can be increased by log M dB, and the width of the emitted beam can be reduced by 1/M of the original width. Thus, the detection of the weak target can be improved, theoretically by log M dB.

The specific implementation of the phased array technology is not limited in embodiments of the present disclosure.

For example, adjusting the beam direction of the antenna can include adjusting the beam direction of the antenna by a rotation structure.

In embodiments of the present disclosure, adjusting the beam direction can be implemented by the phased array, by setting up a rotation mechanism, or by a combination thereof.

For example, adjusting the beam direction of the antenna according to the flight mode can include obtaining the pose information, such as the attitude information, of the UAV and adjusting the beam direction of the antenna according to the flight mode and pose information, such as the attitude information.

During the flight of the UAV, the beam direction of the antenna can also be affected by the attitude of the UAV to cause the beam direction of the antenna to deviate from the area that needs to be detected required by the flight mode of the UAV. Thus, by detecting the attitude information of the UAV, the beam direction of the antenna can be dynamically adjusted according to the attitude information and the flight mode of the UAV. Thus, the beam direction of the antenna can always point to the area that needs to be detected required by the flight mode of the UAV.

For example, adjusting the beam direction of the antenna according to the flight mode and attitude information can include determining a target beam direction of the antenna according to the flight mode and adjusting the beam direction of the antenna to the target beam direction according to the attitude information.

The attitude information can include a pitch angle of the UAV. The beam direction of the antenna can be affected by the attitude of the UAV. For example, when the UAV flies on a route, the beam direction of the antenna can point to the area corresponding to the flight direction of the UAV. When the pitch angle of the UAV changes, the beam direction can change as the pitch angle of the UAV changes. Thus, the beam of the antenna can deviate from the area corresponding to the flight direction of the UAV, and the obstacle in the area corresponding to the flight direction of the UAV cannot be accurately detected. The safety can be lowered during the flight of the UAV. Thus, when the attitude of the UAV changes, the beam direction can be adjusted.

When the UAV is in a flight mode, the pitch angle of the UAV can be measured. For example, the pitch angle of the UAV can be measured by an inertial measurement unit. According to the pitch angle of the UAV, whether the current beam direction of the antenna deviates from the target beam direction can be determined. If yes, the beam direction of the antenna can be adjusted to the target beam direction again through any one or more of the phased array and the rotation structure. Thus, the detection range of the radar module can always cover the area corresponding to the current flight mode to accurately detect the obstacle in the area corresponding to the flight direction of the UAV. The UAV can be controlled to perform an obstacle avoidance flight to improve the safety during the flight of the UAV.

In addition, when the UAV just enters a flight mode, the current beam direction of the antenna may also need to be determined according to the pitch angle of the UAV. Then, the current beam direction of the antenna can be adjusted to the target beam direction through one or more adjustment manners of the phased array and the rotation structure to cause the detection range of the radar module to cover the area corresponding to the flight mode.

For example, adjusting the beam detection of the antenna according to the flight mode can include adjusting the beam direction of the antenna in the pitch direction according to the flight mode.

With different flight modes, different areas may need to be detected. For example, during ascending, an oblique upper area of the UAV may need to be detected. During landing, an oblique lower area of the UAV may need to be detected. Thus, the beam direction of the antenna may need to be adjusted in the pitch direction to cause the beam direction of the antenna to point to the area that needs to be detected required by the flight mode. The beam can be adjusted in the pitch direction through any one or more manners of the phased array antenna and the rotation structure.

For example, the method can further include, according to the flight mode, adjusting a detection distance of the radar module, determining an obstacle avoidance area of the UAV according to the detection distance, and if an obstacle is detected in the obstacle avoidance area, controlling the UAV to perform the obstacle avoidance operation.

The detection distance may not refer to a detection ability of the antenna or radar. The detection distance can be used to define within what distances the obstacle can affect the motion of the UAV or bring danger to the UAV. Different flight modes can have different detection distances. For example, when the UAV is ascending, hovering, and landing, the UAV can keep still or fly slowly. Thus, the detection distance can be adjusted to a relatively small value, e.g., 15 m. When the UAV flies on a route and is in a fast-moving status, a further distance may need to be detected. Thus, the detection distance can be adjusted to a relatively large value, e.g., 50 m.

In embodiments of the present disclosure, the detection distance of the radar can be adjusted to 15 m or 50 m for different flight modes. However, in practical applications, the detection distance of the radar can be adjusted to other distances as needed, e.g., 20 m, 30 m, 40 m, etc. which is not limited in embodiments of the present disclosure.

For example, after adjusting the beam direction, the beam width, and the detection distance of the antenna according to the flight mode of the UAV and the attitude of the UAV, a reception end of the antenna can receive the returned wave signal, and beam synthesis, analog-to-digital converter (ADC) pre-processing, fast Fourier transform (FFT) processing, and angular FFT processing can be performed to determine estimations in three-dimensional parameters such as the distance, azimuth, and pitch angle of the obstacle in the three-dimensional coordinate. Thus, the position of the obstacle can be accurately predicted, and the UAV obstacle avoidance function can be implemented.

For example, adjusting the beam direction and/or beam width of the antenna according to the flight mode can include, when the flight mode is ascent, adjusting the beam direction and/or beam width of the UAV to cause the detection range of the radar module to cover the oblique upper area of the UAV.

When the UAV is ascending, the oblique upper area of the UAV can have a higher collision risk. Thus, the beam direction and/or the beam width of the antenna can be adjusted to cause the detection range of the radar module to cover the oblique upper area of the UAV to detect whether an obstacle exists in the oblique upper area of the UAV. The UAV can be controlled to perform the obstacle avoidance flight according to the detected obstacle to improve the safety when the UAV ascends.

For example, adjusting the beam direction and/or beam width of the antenna can include adjusting the beam direction of the antenna according to a first pitch angle and/or the beam width according to a first field of view angle. The first pitch angle can be 30°˜50°, and the first field of view angle can be ±15°˜±25°.

The first pitch angle corresponding to the beam direction and the first field of view angle corresponding to the beam width can be preset when the flight mode of the UAV is ascent. When the flight mode of the UAV is ascent, the beam direction of the antenna can be adjusted according to the preset first pitch angle, and the beam width can be adjusted according to the preset first field of view angle. The first pitch angle can be selected within a range of 30° to 50°, and the first field of view angle can be selected within a range of ±15° to ±25°.

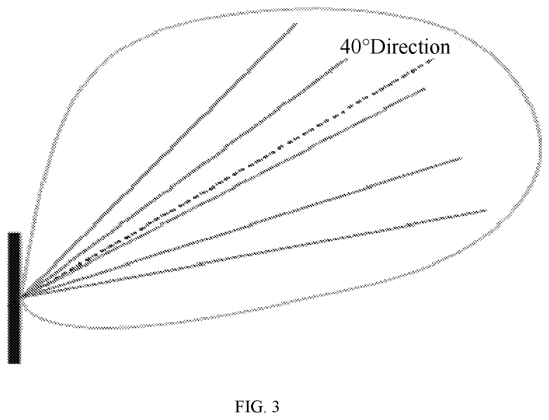

FIG. 3 is a schematic diagram showing a detection range of a radar when an unmanned vehicle is ascending consistent with an embodiment of the present disclosure. The first pitch angle is preset to 40°, and the first field of view angle is preset to ±20°. When the flight mode of the UAV is changed to ascent, the beam direction of the antenna in the pitch direction can be adjusted according to the first pitch angle 40°. The beam width of the antenna in the pitch direction can be adjusted according to the first field of view angle ±20°. The detection distance is 15 m. The adjusted detection range of the radar module covers the area within the range of 20° to 60° in the pitch direction.

For example, adjusting the beam direction and/or beam width of the UAV according to the flight mode can include, when the flight mode is hover, adjusting the beam direction and/or beam width of the antenna to cause the detection range of the radar module to cover the area around the UAV.

When the flight mode of the UAV is hover, the area around the UAV can have a higher collision risk. Thus, the beam direction and/or beam width of the antenna can be adjusted to cause the detection range of the radar module to cover the area around the UAV, detect whether an obstacle is in the area around the UAV, and control the UAV to perform the obstacle avoidance flight according to the detected obstacle. Therefore, the safety of the UAV during hover can be improved.

For example, adjusting the beam direction and/or beam width of the antenna can include adjusting the beam direction according to a second pitch angle and/or the beam width according to a second field of view angle. The second pitch angle can range from −10° to 10°, and the second field of view angle can range from ±45° to ±55°.

The second pitch angle corresponding to the beam direction and the second field of view angle corresponding to the beam width can be preset when the flight mode of the UAV is hover. When the flight mode of the UAV is hover, the beam direction of the antenna can be adjusted according to the preset second pitch angle, and the beam width can be adjusted according to the preset second field of view angle. The second pitch angle can be selected from a range of −10° to 10°, and the second field of view angle can be selected from a range of ±45° to ±55°.

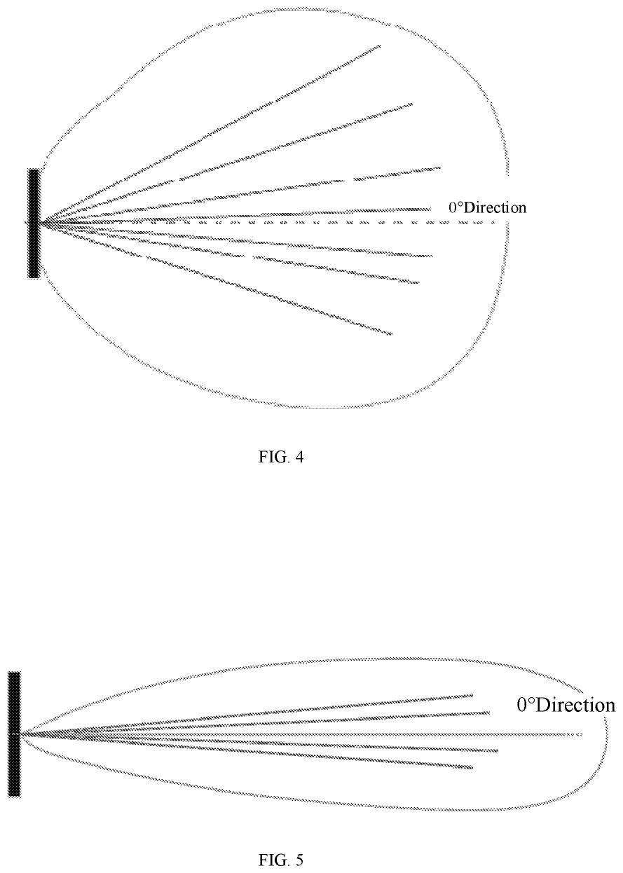

FIG. 4 is a schematic diagram showing a detection range of a radar when an unmanned vehicle hovers consistent with an embodiment of the present disclosure. The second pitch angle is preset to 0°, and the second field of view angle is preset to ±50°. When the flight mode of the UAV changes to hover, the beam direction of the antenna can be adjusted according to the second pitch angle of 0°, and the beam width of the antenna can be adjusted in the pitch direction according to the second field of view angle of ±50°. The detection distance can be 15 m. After adjustment, the detection range of the radar module can cover the area within −50° to 50° in the pitch direction.

For example, adjusting the beam direction and/or beam width of the antenna according to the flight mode can include, when the flight mode is route flight, adjusting the beam direction and/or beam width of the antenna to cause the detection range of the radar module to cover the area corresponding to the flight direction of the UAV.

When the flight mode of the UAV changes to route flight, the area corresponding to the flight direction of the UAV can have a higher collision risk. Therefore, the beam direction and/or beam width of the antenna can be adjusted to cause the detection range of the radar module to cover the area corresponding to the flight direction of the UAV to detect whether an obstacle exists in the area corresponding to the flight direction of the UAV. The UAV can be controlled to perform the obstacle avoidance flight according to the detected obstacle to improve the safety of the UAV during the route flight.

For example, adjusting the beam direction and/or beam width of the antenna can include adjusting the beam direction of the antenna according to a third pitch angle, and/or adjusting the beam width according to the third field of view angle. The third pitch angle can range from −10° to 10°, and the third field of view angle can range from ±10° to ±20°.

The third pitch angle corresponding to the beam direction and the third field of view angle corresponding to the beam width can be preset when the flight mode of the UAV is route flight. When the flight mode of the UAV is the route flight, the beam direction of the antenna can be adjusted according to the preset third pitch angle. The beam width can be adjusted according to the preset third field of view angle. The third pitch angle can be selected from a range of −10° to 10°, and the third field of view angle can be selected from the range of ±10° to ±20°.

FIG. 5 is a schematic diagram showing a detection range of a radar when an unmanned vehicle flies on route consistent with an embodiment of the present disclosure. The third pitch angle can be preset to 0°, and the third field of view angle can be preset to ±15°. The beam direction of the antenna can be adjusted in the pitch direction according to the third pitch angle of 0°. The beam width of the antenna can be adjusted in the pitch direction according to the third field of view angle of ±15°. The detection distance can be 50 m. After adjustment, the detection range of the radar module can cover the area from −15° to 15° in the pitch direction.

For example, adjusting the beam direction and/or beam width of the antenna according to the flight mode can include, when the flight mode is landing, adjusting the beam direction and/or beam width of the antenna to cause the detection range of the radar module to cover an oblique lower area of the UAV.

When the flight mode of the UAV is landing, the oblique lower area of the UAV can have a higher collision risk. Thus, the beam direction and/or the beam width of the antenna can be adjusted to cause the detection range of the radar module to cover the oblique lower area of the UAV. Whether an obstacle exists in the oblique lower area can be determined. The UAV can be controlled to perform the obstacle avoidance flight when the obstacle is detected to improve the safety when the UAV is landing.

For example, adjusting the beam direction and/or the beam width of the antenna can include adjusting the beam direction of the antenna according to a fourth pitch angle and/or adjusting the beam width according to a fourth field of view angle. The fourth pitch angle can range from −30° to −50°, and the third field of view angle can range from ±15° to ±25°.

The fourth pitch angle corresponding to the beam direction and the fourth field of view angle corresponding to the beam width can be preset when the flight mode of the UAV is landing. When the flight mode of the UAV is route flight, the beam direction of the antenna can be adjusted according to the preset fourth pitch angle, and the beam width can be adjusted according to the preset fourth field of view angle. The fourth pitch angle can be selected from a range of −30° to −50°, and the fourth field of view angle can be selected from a range of ±15° to ±25°.

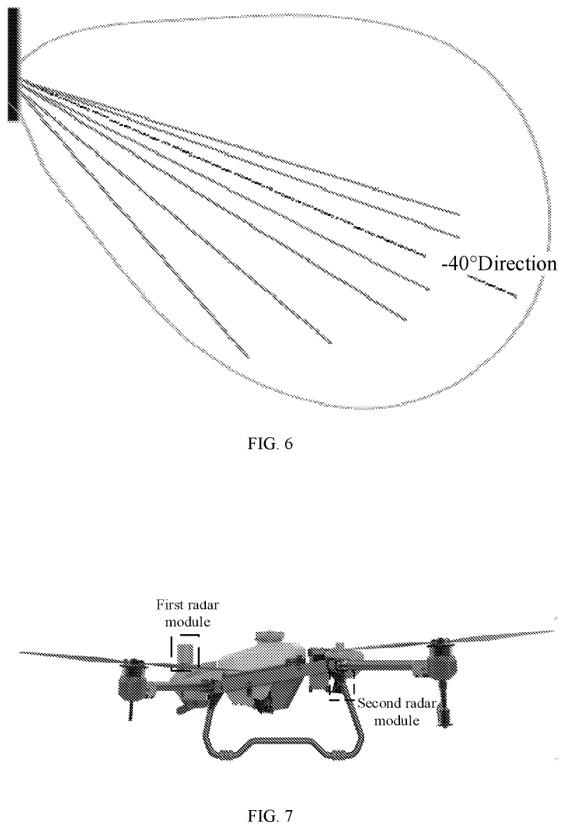

FIG. 6 is a schematic diagram showing a detection range of a radar when an unmanned vehicle is landing consistent with an embodiment of the present disclosure. The fourth pitch angle is preset to −40°, and the fourth field of view angle is preset to ±20°. When the flight mode of the UAV changes to landing, the beam direction of the antenna can be adjusted in the pitch direction according to the fourth pitch angle of −40°, and the beam width of the antenna can be adjusted in the pitch direction is adjusted in the pitch direction based on the fourth field of view angle of ±20°. The detection distance is set to 15 m, and after adjustment, the detection range of the radar module covers the area from −60° to −20° in the pitch plane.

In embodiments of the present disclosure, the values of the first, second, third, and fourth pitch angles/field of view angles can be selected within a certain range. In practical applications, the values of the first, second, third, and fourth pitch angles/field of view angles can be set according to operation needs, which is not limited in embodiments of the present disclosure.

For example, adjusting the beam direction and/or the beam width of the antenna according to the flight mode can include, when the flight mode is terrain-following flight, adjusting the beam direction and/or the beam of the antenna to cause the detection range of the radar module to cover a ground area in front of the flight.

When the flight mode of the UAV is terrain-following flight, terrain change and an obstacle on the ground in front of the UAV may need to be detected to better complete the operation tasks of the UAV. Thus, the ground area in front of the UAV can be determined as a detection area, and the beam direction and/or the beam width of the antenna can be adjusted to cause the detection range of the radar module to cover the ground area in front of the UAV.

For example, adjusting the beam direction and/or beam width of the antenna can include, when the flight mode is terrain-following flight, adjusting the beam direction and/or beam width of the antenna according to an inclined angle of the ground surface.

When the UAV performs the terrain-following flight, the beam direction and/or beam width of the antenna can be adjusted in the pitch direction according to the inclined angle of the ground. For example, the beam direction can be adjusted to be parallel to the ground surface and point to a flight forward direction, the beam direction can be adjusted to point to the ground surface, or the beam direction can be adjusted to point to the ground surface and be inclined toward the flight forward direction. The beam width can be adjusted according to the inclined angle of the ground surface. When the inclined angle of the ground surface is smaller, the beam width can be narrow. When the inclined angle of the ground surface is greater, the beam width can be adjusted to be broader. The purpose is to better detect the obstacle on a sloped surface and better complete the operation task of the UAV.

In some embodiments, the radar module above can be referred to as a first radar module. The first radar module can be located above and in front of the UAV. The UAV can also include a second radar module. The second radar module can be located below and behind the UAV.

FIG. 7 is a schematic diagram of an aerial vehicle with a radar module consistent with an embodiment of the present disclosure. In FIG. 7, a UAV is shown as an example of the aerial vehicle. The UAV includes the first radar module and the second radar module. The first radar module is arranged above and in front of the UAV, and the second radar module is arranged below and behind the UAV.

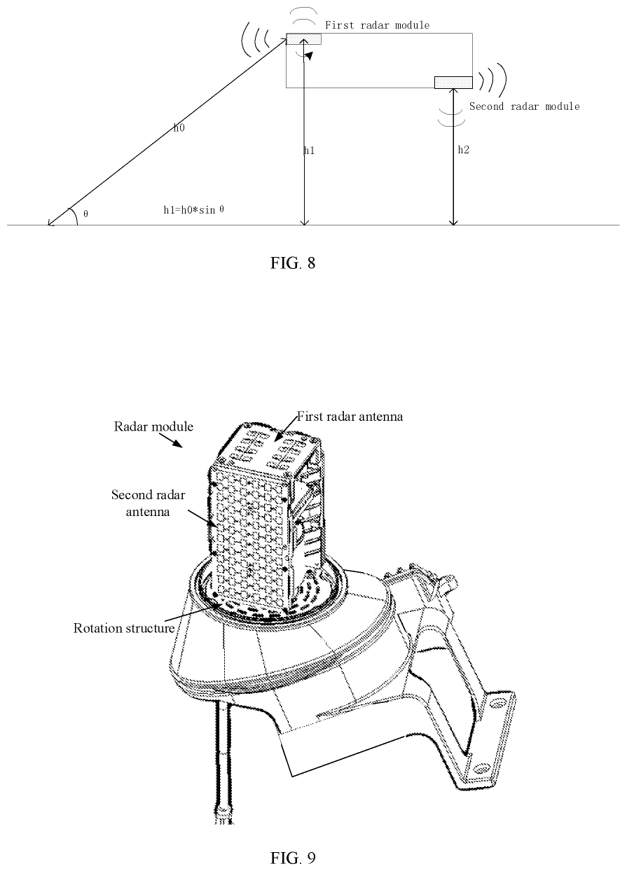

As shown in FIG. 8 and FIG. 9, the first radar module is a rotation radar. The first radar module can rotate 360° in a horizontal direction through a rotation mechanism. The first radar module includes a first radar antenna configured for upper obstacle avoidance and a second radar antenna configured to rotate 360° in the horizontal direction. The second radar antenna can be a phased array antenna with an adjustable beam direction and an adjustable beam width. The beam direction and the beam width of the phased array antenna can be adjusted based on the flight mode of the UAV. The second radar module includes a third radar antenna (not shown in the figure) configured to set a height and a fourth radar antenna (not shown in the figure) configured for rear obstacle avoidance.

Although the second radar antenna of the first radar module can rotate 360 degrees in the horizontal direction, a rear detection blind spot can exist due to the obstruction of the UAV body. Thus, the rear blind spot of the first radar module can be compensated through the second radar module below and behind the UAV. Thus, the obstruction of the UAV structure can be avoided to affect the performance of the radar.

In addition, the detection data of the second radar antenna and the third radar antenna can be used for height fusion. As shown in FIG. 8, based on the detection data of the second radar antenna, distance h0 between the UAV and the ground and angle θ between the distance direction and the ground can be obtained. First height h1 of the UAV relative to the ground can be calculated according to distance h0 and angle θ, h1=h0*(sin θ). Based on the detection data of the third radar antenna, second height h2 of the UAV relative to the ground can be directly obtained. First height h1 and second height h2 can be fused to improve the accuracy of height setting of the UAV to further improve the accuracy of the terrain-following flight of the UAV.

In some embodiments, according to the flight mode of the UAV, the beam direction and/or the beam width of the antenna can be dynamically adjusted to cause the detection range of the radar module to cover the area that needs to be detected required by the flight mode of the UAV. Thus, the obstacle avoidance effect of the UAV can be ensured to improve the safety during the flight of the UAV.

Embodiments of the present disclosure further provide a control device applied to the UAV. The UAV can include a radar module. The radar module can include an antenna. The control device can include a memory and a processor. The memory can be used to store executable instructions that, when executed by the processor, cause the processor to obtain the flight mode of the UAV and adjust the beam direction and/or the beam width of the antenna according to the flight mode. The flight mode can include at least one of ascent, hover, route flight, terrain-following flight, or landing.

For example, the processor can be further configured to obtain the attitude information of the UAV and adjust the beam direction of the antenna according to the flight mode and the attitude information.

In some embodiments, the processor can be further configured to determine the target beam direction according to the flight mode and adjust the beam direction of the antenna to the target beam direction according to the attitude information.

For example, the antenna can be a phased array antenna. The phased array antenna can include a plurality of antenna units. The processor can be further configured to adjust the beam direction of the antenna by adjusting the phase of the signal fed into each antenna unit and/or adjust the beam width of the antenna by adjusting the amplitude of the signal fed into each antenna unit.

For example, the processor can be further configured to adjust the beam direction of the antenna through the rotation structure.

For example, the processor can be further configured to adjust the beam direction of the antenna in the pitch direction according to the flight mode.

For example, the processor can be further configured to adjust the detection distance of the radar module according to the flight mode, determine the obstacle avoidance area of the UAV according to the detection distance, and if the obstacle is detected in the obstacle avoidance area, control the UAV to perform the obstacle avoidance operation.

For example, the processor can be further configured to adjust the beam direction and/or the beam width of the antenna when the flight mode is ascent to cause the detection range of the radar module to cover the oblique upper area of the UAV.

For example, the processor can be further configured to adjust the beam direction of the antenna according to the first pitch angle, and/or adjust the beam width according to the first field of view angle. The first pitch angle can range from 30° to 50°, and the first field of view angle can range from ±15° to ±25°.

For example, the processor can be further configured to adjust the beam direction and/or the beam width of the antenna when the flight mode is hover to cause the detection range of the radar module to cover the area around the UAV.

For example, the processor can be further configured to adjust the beam direction of the antenna according to the second pitch angle and/or adjust the beam width according to the second field of view angle. The second pitch angle can range from −10° to 10°, and the second field of view angle can range from ±45° to ±55°.

For example, the processor can be further configured to adjust the beam direction and the beam width of the antenna when the flight mode is the route flight to cause the detection range of the radar module to cover the area corresponding to the flight direction of the UAV.

For example, the processor can be further configured to adjust the beam direction according to the third pitch angle and/or adjust the beam width according to the third field of view angle. The third pitch angle can range from −10° to 10°, and the third field of view angle can range from ±10° to ±20°.

For example, the processor can be further configured to adjust the beam direction and/or the beam width of the antenna when the flight mode is landing to cause the detection range of the radar module to cover the oblique lower area of the UAV.

For example, the processor can be further configured to adjust the beam direction according to the fourth pitch angle and/or adjust the beam width according to the fourth field of view angle. The fourth pitch angle can range from −30° to −50°, and the fourth field of view angle can range from ±15° to ±25°.

For example, the processor can be further configured to adjust the beam direction and/or the beam width of the antenna when the flight mode is the terrain-following flight to cause the detection range of the radar module to cover the ground area in front of the flight.

For example, the processor can be further configured to adjust the beam direction and/or the beam width of the antenna according to the inclined angle of the ground when the flight mode is the terrain-following flight.

For example, the radar module can be the first radar module. The first radar module can be arranged above and in front of the UAV. The UAV can include a second radar module. The second radar module can be arranged below and at the rear of the UAV.

Embodiments of the present disclosure further provide a UAV, including a body, a power mechanism, and the control device above. The power mechanism can be arranged at the body and configured to provide flight power.

Apparatus embodiments are illustrative. Units that are described as separated members can be or cannot be physically separated. Members shown as units can be or cannot be physical units. That is, the members can be located at one place or distributed at a plurality of network units. Some or all modules can be selected as needed to implement the purpose of the technical solution of embodiments of the present disclosure. Those skilled in the art can understand and implement the present disclosure without creative efforts.

“An embodiment,” “embodiments,” or “one or more embodiments” in the specification can mean that specific characteristics, structures, or features described in connection with embodiments of the present disclosure can be included in at least one embodiment of the present disclosure. Thus, “in one embodiment” may not refer to the same embodiment.

In the specification of the present disclosure, many details are described. However, embodiments of the present disclosure can be implemented without these details. In some embodiments, the known method, structure, and technology are not described in detail to avoid obscuring the understanding of the present disclosure.

In the appended claims, any reference symbols enclosed in parentheses should not be construed as limiting the claims. The word “comprising” does not exclude elements or steps not listed in the claims. The word “a” or “an” preceding an element does not exclude a plurality of such elements. The present disclosure can be implemented by hardware including a plurality of different elements and a computer that is appropriately programmed. In the claims listing units of a plurality of apparatuses. The plurality of apparatuses can be embodied through the same hardware item. The work first, second, and third do not represent any sequence and can be explained as names.

The above are used to describe the technical solution of the present disclosure not limiting the present disclosure. Although the present disclosure is described in detail with reference to the above embodiments, those skilled in the art can understand that modifications can be performed on the technical solutions of embodiments of the present disclosure, or equivalent replacement can be performed on some technical features. These modifications or replacements do not cause the essence of the related technical solution to depart from the spirit and scope of the technical solution of embodiments of the present disclosure.

What is claimed is:

1. A control method comprising:
obtaining a flight mode of an aerial vehicle, the flight mode including at least one of scent, hover, route flight, terrain-following flight, or landing; and
adjusting at least one of a beam direction relative to the aerial vehicle or a beam width of an antenna of a radar module of the aerial vehicle according to the flight mode.

2. The method according to claim 1, wherein adjusting the beam direction relative to the aerial vehicle of the antenna according to the flight mode includes:
obtaining pose information of the aerial vehicle; and
adjusting the beam direction relative to the aerial vehicle of the antenna according to the flight mode and the pose information.

3. The method according to claim 2, wherein the beam direction relative to the aerial vehicle of the antenna is adjusted to cause a beam emitted by the antenna toward a flight direction corresponding to the flight mode.

4. The method according to claim 1, wherein:
the antenna includes a phased array antenna including a plurality of antenna units; and
adjusting the at least one of the beam direction relative to the aerial vehicle or the beam width of the antenna includes at least one of:
adjusting the beam direction relative to the aerial vehicle of the antenna by adjusting a phase of a signal fed into each antenna unit; or
adjusting the beam width of the antenna by adjusting an amplitude of the signal fed into each antenna unit.

5. The method according to claim 1, wherein adjusting the beam direction relative to the aerial vehicle of the antenna includes adjusting the beam direction of the antenna through a rotation structure.

6. The method according to claim 1, wherein adjusting the beam direction relative to the aerial vehicle of the antenna according to the flight mode includes:
adjusting the beam direction relative to the aerial vehicle of the antenna in a pitch direction according to the flight mode.

7. The method according to claim 1, further comprising:
adjusting a detection distance of the radar module according to the flight mode;
determining an obstacle avoidance area of the aerial vehicle according to the detection distance; and
in response to detecting an obstacle in the obstacle avoidance area, controlling the aerial vehicle to perform an obstacle avoidance operation.

8. The method according to claim 1, wherein adjusting the at least one of the beam direction or the beam width of the antenna according to the flight mode includes:
in response to the flight mode being ascent, adjusting at least one of the beam direction relative to the aerial vehicle or the beam width of the antenna to cause a detection range of the radar module of the aerial vehicle to cover an oblique upper area of the aerial vehicle.

9. The method according to claim 8, wherein adjusting the at least one of the beam direction relative to the aerial vehicle or the beam width of the antenna includes at least one of:
adjusting the beam direction relative to the aerial vehicle of the antenna according to a pitch angle, the pitch angle ranging from 30° to 50°; or
adjusting the beam width of the antenna according to a field of view angle, the field of view angle ranging from ±15° to ±25°.

10. The method according to claim 1, wherein adjusting the at least one of the beam direction relative to the aerial vehicle or the beam width of the antenna according to the flight mode includes:
in response to the flight mode being hover, adjusting the at least one of the beam direction relative to the aerial vehicle or the beam width of the antenna to cause a detection range of the radar module of the aerial vehicle to cover an area around the aerial vehicle.

11. The method according to claim 10, wherein adjusting the at least one of the beam direction relative to the aerial vehicle or the beam width of the antenna includes at least one of:
adjusting the beam direction relative to the aerial vehicle of the antenna according to a pitch angle, the pitch angle ranging from −10° to 10°; or
adjusting the beam width of the antenna according to a field of view angle, the field of view angle ranging from ±45° to ±55°.

12. The method according to claim 1, wherein adjusting the at least one of the beam direction relative to the aerial vehicle or the beam width of the antenna according to the flight mode includes:
in response to the flight mode being route flight, adjusting the at least one of the beam direction relative to the aerial vehicle or the beam width of the antenna to cause a detection range of the radar module of the aerial vehicle to cover an aera corresponding to a flight direction of the aerial vehicle.

13. The method according to claim 12, wherein adjusting the at least one of the beam direction relative to the aerial vehicle or the beam width of the antenna includes at least one of:
adjusting the beam direction relative to the aerial vehicle of the antenna according to a pitch angle, the pitch angle ranging from −10° to 10°; and/or
adjusting the beam width of the antenna according to a field of view angle, the field of view angle ranging from ±10° to ±20°.

14. The method according to claim 1, wherein adjusting the at least one of the beam direction relative to the aerial vehicle or the beam width of the antenna according to the flight mode includes:
in response to the flight mode being landing, adjusting the at least one of the beam direction relative to the aerial vehicle or the beam width of the antenna to cause a detection range of the radar module of the aerial vehicle to cover an oblique lower aera of the aerial vehicle.

15. The method according to claim 14, wherein adjusting the at least one of the beam direction relative to the aerial vehicle or the beam width of the antenna includes at least one of:
adjusting the beam direction relative to the aerial vehicle of the antenna according to a pitch angle, the pitch angle ranging from −30° to −50°; and/or
adjusting the beam width of the antenna according to a field of view angle, the field of view angle ranging from ±15° to ±25°.

16. The method according to claim 1, wherein adjusting the at least one of the beam direction relative to the aerial vehicle or the beam width of the antenna according to the flight mode includes:
in response to the flight mode being terrain-following flight, adjusting the at least one of the beam direction relative to the aerial vehicle or the beam width of the antenna to cause a detection range of the radar module of the aerial vehicle to cover a ground area in front of flight of the aerial vehicle.

17. The method according to claim 16, wherein adjusting the at least one of the beam direction relative to the aerial vehicle or the beam width of the antenna includes:
in response to the flight mode being terrain-following, adjusting the at least one of the beam direction relative to the aerial vehicle or the beam width of the antenna according to an inclined angle of ground.

18. The method according to claim 17, wherein adjusting the beam width of the antenna according to the inclined angle of the ground includes:
in response to the inclined angle of the ground being small, adjusting the beam width to be narrow; and
in response to the inclined angle of the ground being large, adjusting the beam width to be wide.

19. The method according to claim 1, wherein:
the radar module is a first radar module; and
the aerial vehicle further includes a second radar module configured to compensate a detection blind spot of the first radar module.

20. A control device comprising:
one or more processors; and
one or more memories storing one or more executable instructions that, when executed by the one or more processors, cause the one or more processors to:
obtain a flight mode of an aerial vehicle, the flight mode including at least one of ascent, hover, route flight, terrain-following flight, or landing; and
adjusting at least one of a beam direction relative to the aerial vehicle or a beam width of an antenna of a radar module of the aerial vehicle according to the flight mode.
